(19) United States
(12) Patent Application Publication
(10) Pub. No.: US 2012/0290150 A1
(43) Pub. Date: Nov. 15, 2012

(54) APPARATUS, SYSTEM, AND METHOD FOR PROVIDING AND USING LOCATION INFORMATION

(76) Inventors: John Doughty, Acworth, GA (US); Charles M. Link, II, Atlanta, GA (US)

(21) Appl. No.: 13/471,331

(22) Filed: May 14, 2012

Related U.S. Application Data
(60) Provisional application No. 61/486,203, filed on May 13, 2011.

(51) Int. Cl. H04W 24/00; G08G 1/00; G06F 7/00

(52) U.S. Cl. 701/2; 701/118; 455/456.3

(57) ABSTRACT

An initiator located on a car energizes an RFID fixed to a roadway. The RFID returns identification and other information. The initiator may include a vehicle mobile device such as a telematics device, or smartphone, which, may couple to an initiator transponder or receiver. A receiver uses the RFID information to perform an action, e.g., using the identifier to generate driving instructions, play advertising content, or generate alerts and warnings for various dangerous conditions and maneuvers. The vehicle mobile device can transmit marker identifiers to a central server for use in traffic flow analysis to count the number of vehicles that transmit a marker's identifier during a period. Marker information can form an instruction upon reaching a given marker traveling at a certain speed to operate the steering wheel at a given angle to follow a predetermined turn radius, or to reduce speed to comply with a reduced speed limit.

### CROSS REFERENCE TO RELATED APPLICATION

This application claims priority under 35 USC sec. 119 to U.S. Provisional Patent Application No. 61/486,203 entitled “Apparatus, system, and method for providing and using location information” having a filing date of May 13, 2011, which this application incorporates herein by reference in its entirety.

### FIELD

Fixed-location programmable/reprogrammable devices, such as radio frequency identifier devices, near field communication devices, or similar electronic devices capable of storing information and reporting same to a proximate reader, or receiver, provide route information to a proximate vehicle device, or mobile device.

### SUMMARY

A vehicle telematics device, or a mobile communication device, (both typically including wireless communication devices) receives information from route-way marker devices, or fixed-location communication devices (the devices preferably are reprogrammable) embedded, or otherwise fixed, in/on/under/beside/proximate to a street, road, or other type of way, such as a highway, a railway, a runway, or a waterway. Other ways could include a jogging trail, a bike path, a hiking path, a route over an ice sheet, a snow-mobile path, a race course, a route within a building such as a hospital, and other routes over differing terrain and through differing conditions and environments. As a vehicle, individual, gurney, bicycle, animal, or other object passes close, or proximate, the fixed-location route marker device, (close or proximate preferably meaning within the transmission range of the marker device which typically corresponds to the strength of an initiation signal from a reader) the mobile device in the vehicle, on is the person, on the animal, or on any other movable object, transmits an initiation signal to the fixed-location route marker. As the initiation signal impinges on the fixed-location route marker, the route marker transmits predetermined information. Alternatively, the fixed route marker device may be powered with a battery or may be hardwired to a permanent power source and may constantly transmit information, or upon receiving an initiation signal may trigger a self-powered marker device to transmit predetermined information stored in it.

For purposes of discussion, this disclosure will focus on a mobile device fixed to, or if not fixed to, associated with so that it moves substantially with, a vehicle. However, the same principles relative to the mobile device in the vehicle apply to a mobile device fixed to, or that moves with, an individual, an animal, or transportation means, such as a motorcycle, a bicycle, a snowmobile, an all-terrain vehicle, an airplane, a boat, a tractor, and other similar modes of transportation.

The fixed location device may have stored in it vector information. For example, the vector information may include current heading of a vehicle traveling in the appropriate direction in a lane corresponding to the device. The mobile device (fixed to a vehicle, or not attached but moving with the vehicle) may use location information and route information corresponding to its location to anticipate the next fixed-location route marker based on a predetermined route, which may be programmed into, or stored in, the mobile device, or a cloud server in communication with the mobile device. Perhaps a mapping database includes surveyed location coordinates and associates them with corresponding fixed-so location route markers' unique identifier information. As personnel install fixed-location route markers along a way, they may survey their locations using traditional transit and pole techniques, or they may use differential Global Positioning Satellite systems to determine accurate location coordinates and elevation information of each RFID. Other methods of determining location coordinates may also be used, such as differential satellite techniques to increase the accuracy of GPS-determined coordinates. The location information may be stored into each corresponding fixed-location device, or may be stored into a database that associates route marker identifiers, route location coordinates, and other route and location information with each other.

Other information may include vector information containing direction and distance details. For example, a database stored on each RFID could contain direction (heading and turn radius and banking angle and elevation change) needed to advance to a next route marker along a desired route. Or, a database stored in, or accessible by, the mobile device, can work in conjunction with fixed-location identifier and coordinates. In response to information received from a fixed-location device along a way, the mobile device in the vehicle, (e.g., a telematics device, or smartphone that communicates with the car) can determine driving inputs (steering, braking, acceleration, etc.) to negotiate a turn. A vehicle control module, or computer device that interacts with control systems or can issue operational control commands, can respond to location information corresponding to fixed-location devices, and can also process information input from other sensors, such as visual or electromagnetic, that interface with references that define a lane (e.g., magnetic paint, wires embedded in a way, guard rails, etc.) in conjunction with inputs from the surveyed fixed-location route marker devices, to promote accurate route following. In the context of a driverless car, or other vehicle, using information from the fixed-location devices in addition to the lane reference means, can, for example, provide the advantage of negotiating a turn where a wire or a paint stripe may break, or have an intentional interruption, to accommodate multiple paths, such as, for example, an exit or intersection.

In another embodiment, cloud computing may perform processing or calculations and the telematics device, or other mobile wireless device, merely receives input from sensors and fixed-location route marker devices, and wirelessly transmits the information from the inputs to a central server, and receives calculated or derived information that the central server determined based on the sensor information and a desired route. An operator using an interface remote from the vehicle (can also be remote from the central server) can view the progress, based on information from fixed-location route markers, of a given vehicle along a route shown on a map using a touch screen display device. The user can create, or update, a route along a displayed map by tracing a desired route with his, or her, finger, a stylus, by entering beginning or end points, or other methods for creating and updating routes. A communications and computing network ‘cloud’ typically comprises many types of, and numbers of, communication and computing equipment devices, and may include multiple communication networks, protocols, operating systems, and applications.

In another embodiment, a remote operator can remotely control a vehicle along a map route by touching an icon representing a vehicle along a route shown on a touch screen display device and moving a finger, or stylus, along a desired route. A protocol for issuing commands could include double tapping the screen to stop the vehicle, and triple tapping to start the vehicle in motion. The vehicle would operate in response to the operator's traced route within predetermined guidelines, which may limit acceleration and deceleration rates, maximum speeds, and lateral acceleration rates. Other algorithms programmed into the vehicle (or in a cloud computing server) can use information from visual, sonic, RADAR, and other object avoidance means, to perform overtaking and passing maneuvers, personnel and animal avoidance, and other object and obstacle avoidance guidance control at the vehicle.

Returning to the discussion of vector information, vector direction might be relative to a previous path of a vehicle instead of relative to true north or adjusted north (considering variation.) Vector information might include exit information. Exit information may include information, such as route numbers of roadways accessible from a given exit. Exit information may also include information about commercial establishments, such as, for example, restaurants, fuel, lodging, tourist points of interest, shopping information, and other similar information of interest to a motorist.

Vector information might include turn information. Turn information may indicate that a turn may use sensors other than fixed-location route markers. The turn information may indicate that a turn in a way uses a wire-in-the-road, a paint stripe, a guard rail (perhaps a guide rail, or wire substantially running parallel to a guide rail). Turn information might also include direction and radius of a given turn. Turn information may include suggestions for vehicle operational parameters, such as speed (throttle position), braking (brake pedal position and master cylinder actuation), and steering angle control.

Fixed-location route markers may also be used to correct dead reckoning in a dead reckoning navigation system or algorithm. Information stored in fixed-location route markers, or associated with their identifier in a database, may include virtual street signs. A vehicle display device, such as a video screen, heads up display, still picture display, or the like, may display route information such as, for example:
weight limitation for roads and bridges;
vehicle length limitations;
Maximum limit on number of axles a vehicle can have;
height limitations;
rest area location and, related information;
park information; and
road hazard warnings, such as falling rocks, deer crossing, etc.;

Route information contained in a fixed-location route marker, or associated with identifiers of corresponding route markers, may vary depending upon the lane of travel in a multi-lane way. For example, the information may include:
different advertising based on whether a lane is a turn lane or a thru-lane;
two parallel turning lanes typically have different radii, thus fixed-location route markers corresponding to the two different lanes may include different turn information.
Route information may include vehicle class limitations and route information may include speed limitations based on class limitation.

If an initiator device transmits a vehicle's VIN, or other identifying information in a message, the fixed location route marker device may respond with targeted marketing information based on the VIN of a vehicle passing over, or by, it. The vehicle device/initiator device may transmit certain of the alphanumeric characters of a vehicle's VIN, or other means that may be used to identify a vehicle type or device type. These alphanumeric characters preferably correspond to the non-specific characteristics of the vehicle (i.e., the digits and letter other than the sequential serial number portion that could identify a particular user). This information can provide a basis for targeting advertising to a driver of a vehicle, or user of a particular device based on the vehicle. For example, if the character identifying the manufacture of a vehicle indicates a vehicle as a premium, or luxury, brand, and the character that identifies the model year of the vehicle indicates the vehicle as only one or two years old at most, then advertising for an expensive product, service, or vacation may be displayed in the vehicle or on the mobile device. Alternatively, the information relative to the type of vehicle may be used to determine an advertisement to display on a near-by billboard or other advertising medium. The advertising may be stored in the fixed-location route marker device, or in information retrieved from the route marker in response to an initiation signal. Or, the mobile device in the vehicle (telematics device, or smartphone, or similar) may transmit the route marker's identification information, and perhaps location coordinates, to an advertising server via a communication cloud coupled to the billboard, and the cloud can determine an appropriate advertisement based on the vehicle type and age.

In another aspect, the route marker device may provide wrong-way warning information. For example, if a driver turns into a lane going the wrong direction (i.e., against traffic flow direction for that lane) the mobile device associated with the vehicle may compare (or transmit to a communication cloud for comparison) location information received from a currently proximate, and from the most recently proximate, route marker, with route and way information stored in a database to determine that the driver may be in danger of encountering oncoming traffic. Alternatively, the vehicle device may use GPS heading information in conjunction with location information from a fixed-location route marker the vehicle has recently encountered to determine and warn that the vehicle is traveling opposite the direction it should be for the lane corresponding to the route marker.

In another alternative embodiment, a standard road system design specification may specify that installers install each fixed route marker corresponding to a given travel lane so that identifiers of respective route marker devices follow a mathematics/numerical pattern, such as increment, as a traveler travels in the lane in the proper direction. For changeable direction lanes, special identifier codes from the route markers may identify the lane as a changeable lane and an application and device programmed to determine the correct lane direction based on time of day, for example, or updated information from a authority such as a department of transportation, can receive and process the route marker identification and corresponding information to determine and warn a user that he, or she, is traveling in the wrong direction. A receiving device in the traveling vehicle, or other mobile communication device, can generate a warning, such as an audible alarm, audible message, flashing light, or other form of alert based on a wrong way determination. In addition, if the mobile receiving device, or associated mobile device, determines that the vehicle is traveling the wrong way, it may be configured to instruct actuators in the corresponding vehicle to steer into a different lane, to automatically apply the vehicle's braking system, or perform another corrective action.

Techniques for programming, or storing information into, a route marker device may include sending the information in an initiation signal that includes a message comprising the information to be stored and a code identifying the message as information to be stored. Or, the information could be stored to the device when it is manufactured.

If the information to be stored is stored, or updated, in the field (the location where the route marker will be used), the device sending the initiating signal can program the route marker when the marker location is surveyed, or while the initiating/programming device passes over, or proximate, the route marker.

Information stored in a fixed-location route marker may include information relative to a locality close to the marker. A mobile device passing proximate the marker may initiate the marker and trigger it to send the information relative to the locality, including dining, lodging, fuel and energy station information, area attractions, local school information, directions to local government agencies, demographic information about the locality, history of the locality, geographic and topographic information, and any other information that may be of interest. The information may be stored in a predetermined format, and an application running on the mobile device, or running on a remote computer device or mobile device, can display the information in a predetermined format using a user interface that is part of the application.

### BRIEF DESCRIPTION OF THE DRAWINGS

FIG. 1 illustrates a two-way roadway with route markers placed in the center of one of the lanes.

FIG. 2 illustrates an automobile passing over a location-based route marker.

FIG. 3 illustrates, a flow diagram of a method for performing an action using information dynamically received from proximate fixed-location communication devices.

### DETAILED DESCRIPTION

The processing of the disclosed methods and systems can be performed by software components. The disclosed system and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based, cloud based, and distributed computing environments where tasks are performed by remote processing devices that are linked through a communications network. In a distributed computing environment, program modules can be located in both local and remote computer storage media including memory storage devices.

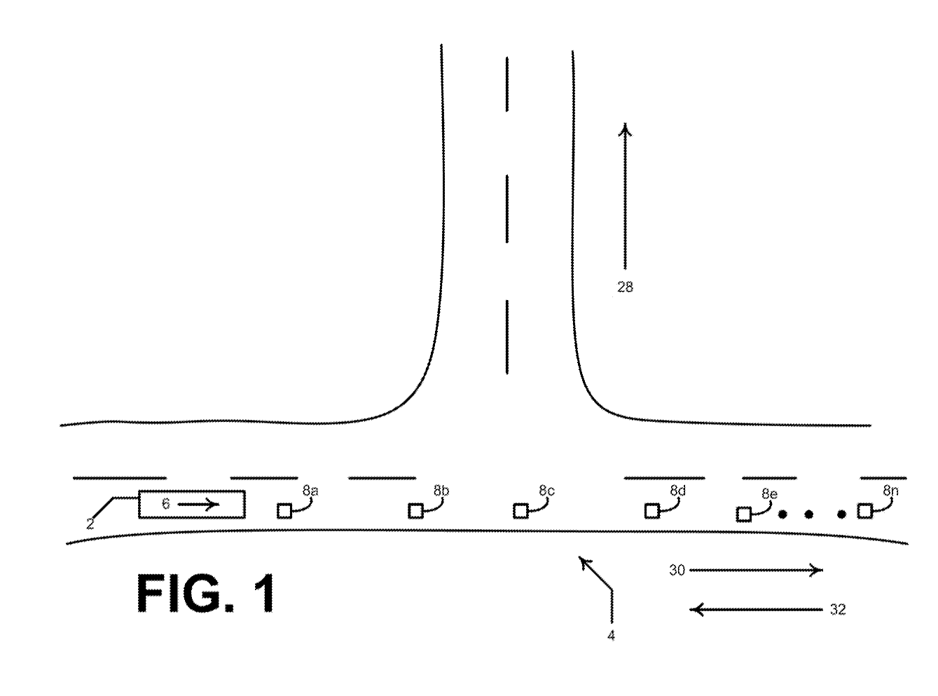

Turning now to the figures, FIG. 1 illustrates a vehicle 2 traveling on two-way roadway 4 in direction 6. Multiple fixed-location route markers 8 are placed in predetermined, or known, locations, in the center of the lane vehicle 2 is traveling in.

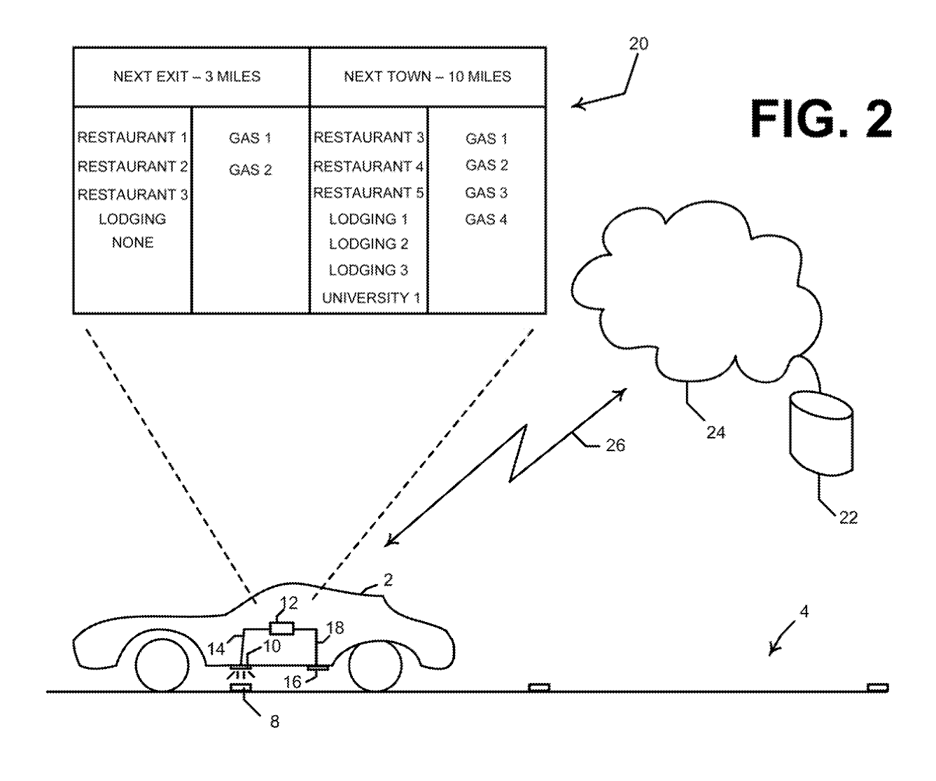

Turning now to FIG. 2, the figure illustrates an embodiment in which vehicle 2 traveling on roadway 4 encounters fixed-location route marker 8. An initiation signal transponder 10, or similar device, broadcasts an initiation signal. Initiator 10 typically has a predetermined beam pattern so that that the initiation signal energizes marker 8 and transmits an information/request message, if any, to provide enough time for the marker to perform a task the initiation signal may request before a receiver/reader—typically part of the initiator—has moved outside the marker's transmission range.

The figure shows initiator transponder 10 coupled to a vehicle mobile device 12, such as a telematics control unit fixed to vehicle 2, or the mobile device may comprise a user's smartphone, or similar mobile device. Either a smartphone or a fixed telematics device performing the functionality of processing signals to and from initiator 10 can couple to the initiator via link 14, which may comprise a wired connection or a wireless connection, for example via Blutooth®, Wi-Fi®, or other wireless connection.

In another embodiment, separate reader/receiver 16 may provide information it receives in a signal sent in response to an initiator signal via link 18 to mobile device 12. By separating receiver 16 from initiator transponder 10, an antenna of the receiver may have a better ‘view’ (closer proximity thus a higher signal gain relationship with marker 8) than if transponder 10 includes the receiver. The advantage, provided by separating receiver 16 from the initiator 10 may increase for fast moving vehicles. In addition, having separate devices may simplify facilitating different antenna beam patterns for initiation and for receiving.

FIG. 2 also illustrates a typical display of information 20 that mobile device 12 may generate in response to receiving information from marker 8. If marker 8 only replies to an initiation signal with its identifier, then device 12 may perform a is lookup based on the identifier and determine driver information that corresponds to the marker. For example, a driver of car 2 may want to know the distance to the next exit along an interstate, or other controlled access highway. Or, he, or she, may want to know the distance to the next city, town, or village. Display 20 shows that from marker 8, the next exit lies three miles ahead and the next town lies ten miles ahead along roadway 4 vehicle 2 is traveling. Display 20 provides details of information germane to the driver, such as information about restaurants, fueling stations, and lodging. The amount, and type, of information is limited only by the database, table, or other collection of information that cross references an identifier of marker 8 with data and information.

Database information may be stored on marker 8 itself, or on a table in mobile device 12. In addition, database information may be stored at a remote server 22, which is connected to communication network cloud 24. Mobile device 12 typically connects with cloud 24 via a wireless link 26, although when stationary, the mobile device may connect to the cloud via a wire for data and information updates, including software and database upgrade and updates. One skilled in the art will appreciate that cloud 24 can include myriad communication systems, including wireless voice and data networks, the world wide web, other aspects of the Internet, one or more intranets, wireless networks such as Bluetooth and wi-fi, and other similar communication network types and protocols that exist currently and that may be created.

Algorithms that process information received from marker 8 and that make determinations based on the information may run on the marker itself, preferably on the mobile device, or on devices and apparatuses coupled to cloud 24. As an example, and in reference to FIG. 1, the driver of vehicle 2 may have a desired route that calls for turning left at the intersection shown in the figure. The route may be programmed into an onboard navigation system, or into a remote server that runs application and stores data for users. As cloud computing speeds increase over time, this embodiment may, and probably will, become the ubiquitous way for facilitating many computing tasks, but presently, an algorithm running on a mobile device coupled to a vehicle or a smartphone moving with the vehicle is the best mode for performing algorithms that process route marker data.

As an example of an algorithm that processes route marker data and information, as vehicle 2 passes over, or proximate, marker 8a, an initiator substantially moving with the vehicle sends an initiation signal to energize the marker. Preferably, marker 8a responds with at least its unique identifier. The device processing this data may look up information associated with the identifier and retrieve the driver's preferred route, which includes making a left-hand turn at the intersection shown in the figure. In addition, the information associated with marker 8a may include instructions that when vehicle 2 passes marker 8b, it should apply brakes, and/or turn the steering wheel at a certain angle, to negotiate the turn. Plainly, for a driverless car application, vehicle 2 could also rely on accident avoidance methods and means, such as inputs from RADAR, SONAR, video, electromagnetic, and other sensors. In addition, cloud computing may also process information about a vehicle traveling in the lane for the opposite direction, and could provide a warning to a navigation/guidance system of vehicle 2 that it will need to pause before making the left-hand turn because a vehicle is approaching the same intersection from the opposite direction, and, based on the current speeds of vehicle 2 and the other vehicle, they will both arrive at the intersection within a predetermined interference period. In another useful embodiment, based on a predetermined desired route to turn left, as an initiator device corresponding to vehicle 2 initiates a response from marker 8a, the device processing the marker information may display information regarding fuel stations, restaurants, lodging, and other points of interest along the road following direction 28. Or, knowing that the desired route is to turn left and to proceed in direction 28, if a processing device corresponding to vehicle 2 receives an identifier from one of markers 8c, 8d, . . . 8n, then it can generate an alert that the vehicle failed to turn and is instead following road 4 in direction 30.

As another example, if vehicle 2 is a heavy truck traveling in direction 6, a mobile device may generate a message upon receiving identification information from marker 8a alerting a driver of the truck that a bridge farther up the road in direction 30 has a weight limit lower than the current, loaded weight, of the truck. Thus, the driver can turn left and follow direction 28, which may be an alternate route to following direction 30. This would prevent having to turn around and backtrack after reaching the bridge with the low weight limit.

Turning back to FIG. 2, in another embodiment, as initiator 10 sends an initiation signal and message to marker 8, it can include certain characters from predetermined positions of the YIN of vehicle 2. Using power from initiator 10 (or from an alternate source if self powered), marker 8 can select from multiple, stored, advertisements based on an assumed demographic corresponding to the VIN. If the VIN information indicates a late model luxury brand automobile, marker 8 may return advertising targeted to an affluent purchaser. If the VIN information indicates a delivery van or a base model work truck, even if relatively new, marker 8 may select an advertisement message to return to the vehicle targeted to a product that a technician might purchase. One skilled in the art will appreciate that the mobile device 12 could also receive advertisements that correspond to multiple locations along a route. As vehicle 2 passes a given route marker, mobile device 12 can display advertisement content corresponding to the route marker's identifier, or location coordinates. In another embodiment, mobile device 12 can transmit its VIN information along with a given marker identifier, or the marker's location coordinates, to a cloud server, which could then cause a billboard, or other type media content player, to play an advertisement based on a demographic associated with the VIN information.

In another embodiment, if installers have installed markers 8a-8n according to a pattern, such as, marker identifiers incrementing in the direction of correct travel in the lane, the marker identifiers can be used to detect wrong-way driving. For example, as a vehicle encounters marker 8e, it receives and stores the marker's identifier to a memory. If the same vehicle later receives the identifier from marker 8d, a mobile device in the vehicle, or a cloud computing device, can determine that the vehicle is traveling in direction 32, which is the wrong direction for the lane markers 8a-8n are installed in. The mobile device in the vehicle would then alert the driver of the wrong-way vehicle, to steer into the correct lane, if possible. Or, in a driverless car scenario, the mobile device could cause the vehicle to steer itself into the correct lane if possible (i.e., no divider between lanes, and no vehicle next to the subject vehicle) if there is no immediate threat of a head on collision. If the vehicle cannot be safely steered into the correct lane because of a lane divider, or because of a car in the correct lane next to it, the mobile device could cause the vehicle braking system to operate and either stop the vehicle or slow it so that it could then steer into the correct lane behind the adjacent vehicle.

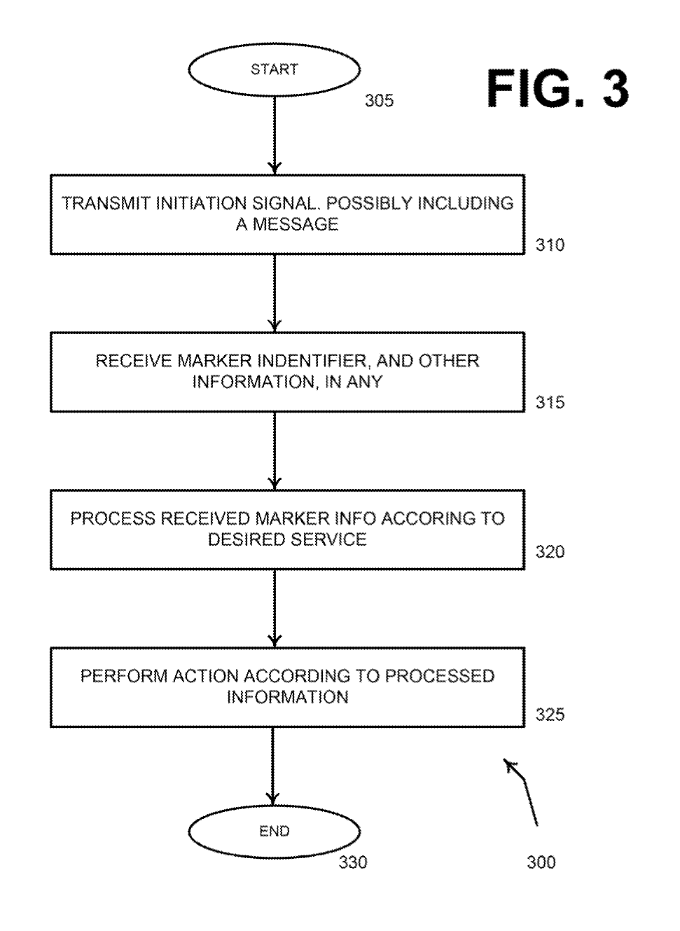

Turning now to FIG. 3, the figure illustrates a flow diagram of a method 300 for performing services using information received from fixed-location route markers. Method 300 begins at step 305. At step 310, a device, typically installed in, or moving with, a vehicle transmits an initiation signal. The initiator device may be constantly powered and have a conical shaped radiation beam pattern so that it focuses its transmit power in the presumed general direction a route maker is likely to be. Upon receiving the transmitted initiation signal, the route marker uses power from the received initiation signal to power its internal processor and transmitter to transmit at least an identifier unique to it, and preferably other information stored in it. The additional information may include route-specific advertising content, or route-specific way information such as, for example, turn information, information about nearby establishments, weight and height limits, and points of interest. In addition, the initiation signal may include message information from the sending device, such as a vehicle's VIN or a request for fuel station information.

At step 315, a receiving device receives, or reads, a signal the route marker transmits in response to the initiator signal. The information received at step 315 may include advertising content or turn information, as examples, in addition to the route marker's unique identifier. If the information received from the route marker only includes the marker's unique identifier, the receiving device in the vehicle, typically a telematics device fixed to the vehicle, or a mobile user device, such as a smartphone that can perform telematics functionality, processes the received marker identifier, to retrieve information associated with the identifier. Alternatively, the mobile device transmits (typically wirelessly) the identifier to a communications network cloud, which may return information associated with the identifier, if any exists. The information associated with the marker's identifier may include turn information, lane direction information, food, lodging, and fuel, information, turn information, advertising content and information, or even multimedia content that the driver may have predetermined it would like to play when he, or she, reaches a predetermined location along a predetermined route.

At step 320, the marker information is processed according to a desired service. For example, the device performing the processing may be a navigation application. When the vehicle passes a given marker, the navigation system can process the marker identifier and generate driving directions based on the speed and steering wheel angle at step 320. The driving directions may include instructions to slow down, apply the brakes, and begin turning a given direction if a change of lane or a turn is necessary to follow a predetermined route. Or, the device performing the service may be a telematics application that processes vehicle diagnostics and operational information, in addition to route marker information. If the telematics device determines that the vehicle is low on fuel, and an inquiry to a navigation system (either of which may be located remotely as assumed as components of a network cloud) indicates that after an upcoming exit from the current roadway no other fuel station exists before the vehicle will run out of fuel, or energy, the telematics system can alert the driver at step 320, via a visual or audible warning, to turn at the next exit to refuel, or recharge, or otherwise resupply its store of energy. The method ends at step 330.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations can be made without departing from the scope or spirit. Other embodiments will be apparent to those skilled in the art from is consideration of the specification and practice disclosed herein. It is intended that the specification and examples be considered as exemplary only, with a true scope and spirit being indicated by the following claims.

What is claimed is:

1. A system for providing information to a mobile device, comprising:
an initiation signal generating means substantially fixed to a vehicle;
a receiver means for receiving an information signal from a fixed-location communication device, wherein the fixed-location communication device is substantially fixed to a way which the vehicle travels along and wherein the fixed-location communication device provides information in an information signal proximate the vehicle in response to a initiation signal generated by the initiation signal generating means; and
a means for conveying information to a user of the vehicle the information in the information signal received from the fixed-location device, wherein the means for conveying is coupled to the receiver means via a communication link.

2. The system of claim 1 wherein the way is a roadway.

3. The system of claim 1 wherein the vehicle is an automobile.

4. The system of claim 1 wherein the fixed-location communication device is a passive near field communication target device.

5. The system of claim 4 wherein the fixed-location communication device is an RFID target device.

6. The system of claim 4 wherein the fixed-location communication device comprises a paint stripe that visually indicates a desired path along the way, wherein paint that composes the paint stripes contains magnetic matter.

7. The system of claim 1 wherein the vehicle contains at least one actuator for controlling an operational function of the vehicle in response to information received in the information signal.

8. The system of claim 1 wherein the information contained in the information signal is location based information.

9. The system of claim 1 wherein the means for conveying information to a user of the vehicle includes a display screen substantially fixed to the vehicle.

10. The system of claim 1 wherein the means for conveying information to a user of the vehicle comprises:
the receiver means, wherein the receiver device includes a short range wireless transceiver; and
a smartphone configured to communicate with the receiver device via a wireless link established with the shortrange wireless transceiver.

11. The system of claim 1 wherein the receiver means is configured to wirelessly update information stored in the fixed-location communication device.

12. The system of claim 11 wherein the information stored to the fixed-location communication device includes advertising content.

13. The system of claim 11 wherein the information stored to the fixed-location communication device includes point of interest information.

14. A method for providing information to a mobile device, comprising:
generating an initiation signal with a means for generating an initiator signal wherein the means for generating is substantially fixed to a vehicle;
receiving an information signal with a means for receiving an information signal from a fixed-location communication device, wherein the fixed-location communication device is substantially fixed to a way which the vehicle travels along and wherein the fixed-location communication device provides information in an information signal to the vehicle in response to a initiation signal generated by the initiation signal generating means; and
conveying the information received from the fixed-location device in the information signals to a user with a means for conveying information to a user of the vehicle, wherein the means for conveying is coupled to the means for receiving via a communications link.

15. The method of claim 14 wherein the means for conveying is a smartphone.

16. The method of claim 14 wherein the communication link is a Wi-Fi®link.

17. A method for providing information to a mobile device, comprising:
generating an initiation signal with a means for generating an initiator signal wherein the generating means is substantially fixed to a vehicle;
receiving an information signal with a means for receiving an information signal from a fixed-location communication device, wherein the fixed-location communication device is substantially fixed to a way which the vehicle travels along and wherein the fixed-location communication device provides information in an information signal to the vehicle in response to a initiation signal generated by the initiation signal generating means; and
transmitting the information received from the fixed-location device in the information signal to a central host computer remote from the vehicle over a wireless communication link.

18. The method of claim 17 wherein the communication link is a long range wireless communication link.

19. The method of claim 18 wherein the long range communication link is a mobile wireless communication link.

20. The method of claim 17 wherein the central host computer is configure for analyzing received information from the vehicle with a mathematical algorithm to update a traffic congestion map.
